(19) United States
(12) Patent Application Publication
(10) Pub. No.: US 2007/0031630 A1
(43) Pub. Date: Feb. 8, 2007

(54) BAMBOO BUILDING COMPONENTS

(76) Inventors: Patrick Chu, Walnut Creek, CA (US); Tim Chu, Walnut Creek, CA (US); Ted Lo, Danville, CA (US)

Correspondence Address: WEST & ASSOCIATES, A PC, 2815 MITCHELL DRIVE, SUITE 209, WALNUT CREEK, CA, 94598, US

(21) Appl. No.: 11/463,298

(22) Filed: Aug. 8, 2006

Related U.S. Application Data
(60) Provisional application No. 60/706,858, filed on Aug. 8, 2005.

(51) Int. Cl. B32B 3/10

(52) U.S. Cl. 428/54; 428/55; 428/56

(57) ABSTRACT

A building material comprised of sectioned and flattened bamboo, or synthetic bamboo, which may be produced with an optional reinforcing backing material and a variety of finishes and treatments. This building material can be produced in various configurations and geometries for many construction applications, including roofing, siding, and paneling.

### CLAIM OF PRIORITY

This application claims the U.S. Provisional Application No. 60/706,858, filed Aug. 8, 2005, the complete contents of which is incorporated herein by reference.

### BACKGROUND

1. Field of the Invention

The present invention relates to the field of building and construction materials.

2. Background

Builders currently use a variety of roofing materials in construction. Depending on cost, aesthetic, and environmental considerations, a roof may be made of wood, steel, or composite shingle, clay or concrete tile, corrugated steel, synthetic materials, or hot mop tar and gravel. Although all of these materials are commonly used, they each present several drawbacks.

Wood shingles are easy to install and look good when first installed. However, when exposed to the elements, they discolor, warp, and swell. In addition, in damp environments, these shingles can rot and harbor moss. All of this not only diminishes the look of the shingles, but can also compromise the integrity of the roof. As a result, wood shingles must be replaced with a higher frequency than other roofing materials, which can be costly in supplies and labor. Finally, wood shingles can be a fire hazard and have been banned in some areas with a high fire risk.

Although the light weight of composite shingles is convenient for installation and they are more fire-resistant, the durability of the resulting roof is questionable, particularly in damp environments. In addition, these shingles require a wearing-in period, which can be inconvenient for homeowners. Further, consumers may be put off by the unattractive look of these shingles.

Clay tiles, although attractive, are heavy, very brittle, and difficult to install. Further, even if they are installed successfully, clay tiles are subject to frequent breakage and often need to be replaced. Concrete tiles are less brittle, but are still heavy and require a great deal of labor to install.

A metal roof may be quick and inexpensive to install, but is subject to many problems in use. Since a sheet metal or corrugated steel roof is thin, it easily dents when hit and buckles under strain. This is particularly a problem in areas that experience hail and snow, or even in an heavily-treed area where branches and other tree parts often fall. In addition, the thin structure of a metal roof fails to provide any insulation, which presents a problem in either warm or cool climates. Finally, a metal roof rusts with exposure and can also be damaged by galvanic reactions with other metal materials.

Bamboo has long been used as a natural building material in tropical climates due to its structural integrity and resistance to the elements. It is strong and light, yet does not buckle or bend like metal. In addition, it is not susceptible to rust or galvanic reactions like metal. Unlike wood, it does not rot, shrink, warp, swell, or fade, although it does acquire a deeper tone with exposure. Since bamboo is a grass instead of wood, it is also not susceptible to termites or dry rot damage. Further, bamboo is a renewable and sustainable resource.

Bamboo also has a higher flash point than wood, making it safer and appropriate for use in places where wood shingles are not allowed. Although the base shape of bamboo is conducive to tile, it could be transformed into a shingle configuration as well. Either way, bamboo would provide a well-insulated roof, with respect to both noise and heat, that is easy to install. Although bamboo does split when nailed, this drawback may be overcome with alternate attachment techniques.

The same properties that make bamboo an outstanding roofing material also make it suitable for use as paneling, siding, or other construction components. It is lightweight, strong, and resistant to wear and decay, while also providing insulation. It can be processed into a variety of configurations to fill many construction needs. Further, synthetic materials that emulate these bamboo qualities may provide the same advantages

What is needed is a bamboo or synthetic bamboo material for roofing and other construction applications and a process by which to manufacture a component system of this material for efficient and effective installation.

### BRIEF DESCRIPTION OF THE DRAWINGS

FIG. 1 depicts a perspective view of an embodiment of the present material

FIG. 1(a) shows a side view of this embodiment.

FIG. 1(b) shows a front view of this embodiment.

FIG. 1(c) shows a back view of this embodiment.

FIG. 2 shows a perspective view of an alternative embodiment of the present material.

FIG. 3 shows a perspective view of a panel shingle embodiment with an optional reinforcing backing material.

FIG. 4 shows a perspective view of a panel shingle embodiment with an alternative embodiment of a reinforcing backing material.

FIG. 5 shows another panel shingle embodiment of the present material.

FIG. 6 depicts a perspective view of the ridge cap embodiment of the present material.

FIG. 6(a) shows a side view of the ridge cap embodiment.

FIG. 6(b) shows an end view of the ridge cap embodiment.

FIG. 7 shows a ridge cap embodiment in use with shingle embodiments.

### DETAILED DESCRIPTION

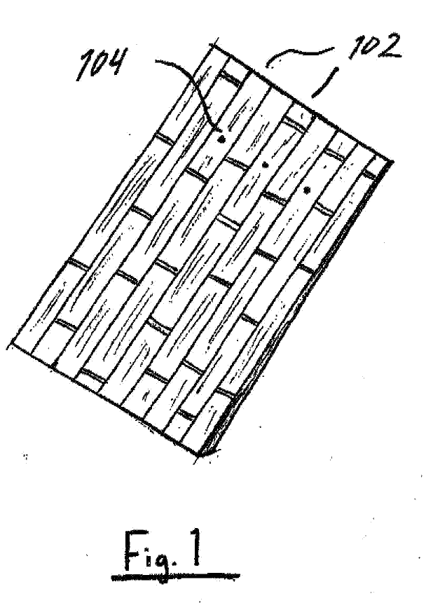

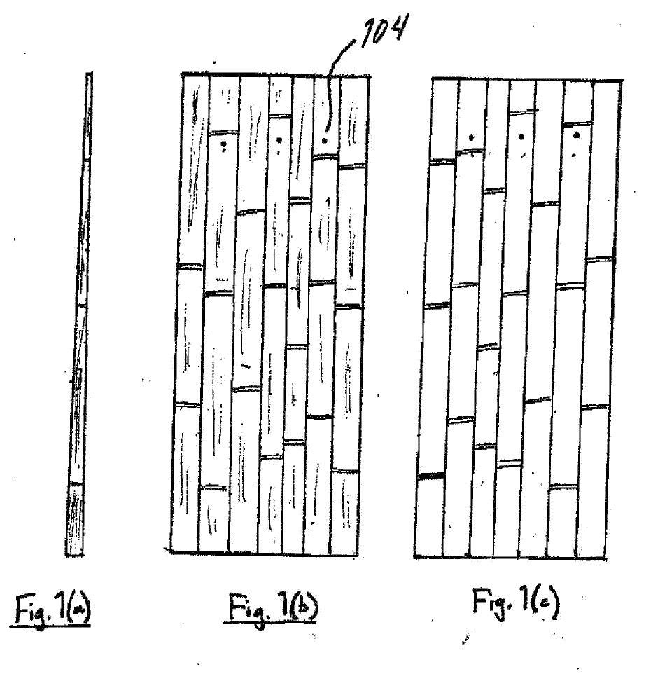

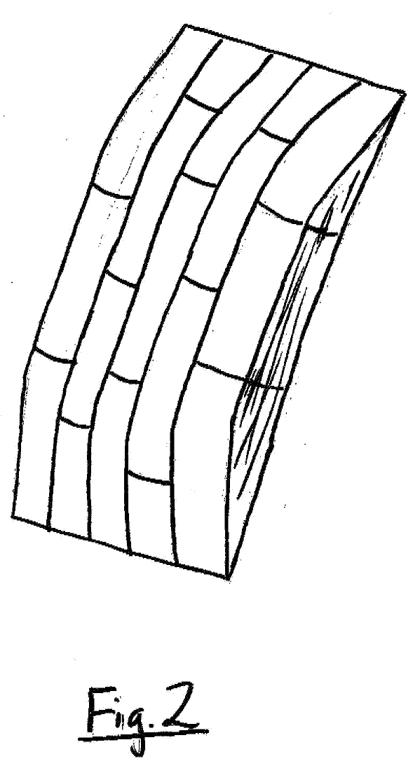

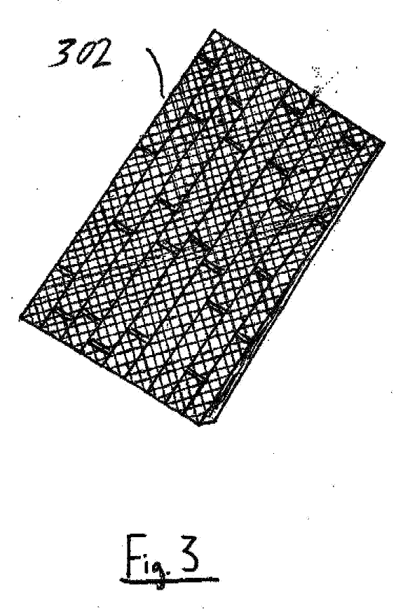

FIG. 1 depicts a perspective view of one embodiment of the present material. Bamboo stalks can be sectioned into pieces 102 and flattened into a substantially planar configuration. The stalks 102 can then be arranged and joined together by any known and/or convenient bonding agent. Here, the resulting bonded bamboo material is depicted in a rectangular panel or shingle piece. The piece can then be treated with various finishes and treatments to provide aesthetic appeal and protection from the elements. Holes 104 can be cut into the piece at any known and/or conventional position into the planar surface and oriented at any known and/or conventional angle relative to the planar surface.

In some embodiments, the piece can then be attached to the rest of the construction by nails, staples, or any other known and/or conventional device.

In FIG. 1, the sectioned bamboo stalks 102 are depicted as arranged in an adjoining flush configuration. Any known and/or conveniently used bonding agent can be applied to the adjoining longitudinal edges of the sectioned bamboo stalks 102 to bond them together along this edge. However, the bamboo stalk sections 102 can also be overlapped, interwoven, or otherwise combined in any known and/or convenient fashion. In addition to the rectangular strips shown in FIG. 1, the sectioned bamboo stalks 102 can be cut into various geometric shapes and arranged in a variety of patterns. These various combinations and configurations can serve both structural and aesthetic purposes by adding strength to the bamboo layer, as well as attractive patterns and textures to the piece. A piece can then be designed to meet specific structural or aesthetic needs.

The sectioned bamboo stalks 102 can also be made from a synthetic bamboo material and arranged and bonded in an adjoining flush configuration. Any known and/or conveniently used bonding agent can be applied to the adjoining longitudinal edges of the sectioned synthetic bamboo stalks 102 to bond them together along this edge. However, the synthetic bamboo stalk sections 102 can also be overlapped, interwoven, or otherwise combined in any known and/or convenient fashion. In addition to the rectangular strips shown in FIG. 1, the synthetic bamboo stalks 102 can be cut into various geometric shapes and arranged in a variety of patterns.

The bamboo stalk sections 102 can be bonded by any known and/or convenient bonding agent. Such agents can include, but are not limited to, epoxies, water-based adhesives, films, and thermosetting adhesives. These agents can vary depending on factors such as the structural strength and durability required for a particular application. Manufacturing costs and aesthetic considerations can also be factors in selecting an appropriate bonding agent. The bonding agents can be applied to the surfaces of the bamboo stalk sections 102 or otherwise integrated with the bamboo stalk sections 102 themselves, such as, but not limited to, being “sandwiched” between bamboo stalk sections 102. The bonding agent can function only as a contact agent to hold the bamboo stalk sections 102 together, to be finished further with another applied finish, or can also provide a protective or aesthetic finish.

The resulting bonded bamboo material can either be manufactured to particular dimensions, or produced in larger sheets and subsequently cut into any known and/or convenient planar shape, geometry, or dimensions. FIG. 1 depicts a typical rectangular panel or shingle piece, although the piece can be configured into a variety of planar polygonal shapes as well. The holes 104 can be round, square, or any other known and/or commonly used shape to accommodate the desired attachment components.

FIG. 1(a) depicts a side view of this embodiment. The piece shown in FIG. 1(a) has a single taper running lengthwise along the piece, with a thicker portion at one edge of the piece, and a thinner portion at the opposite end. This embodiment can typically be used as a roofing tile or siding shingle, with the thicker end oriented towards the lower end of the roof of wall, but can also be positioned in any other convenient or desired orientation. Although depicted here with a single taper, a piece of the material can also be of uniform thickness or of other varying thicknesses.

Either the bottom surface or backside, or top surface or frontside, of the piece can also be tapered to create a double-wedge profile, as depicted in FlG. 2. In this embodiment, the piece can be made with a double taper running lengthwise along the piece, with a thicker portion along the lateral midsection of the top surface thinning down to opposite edges. Both top and bottom surface can also be tapered in this manner. Again, this embodiment can be typically used in roofing or siding tiles or shingles. The pieces can be positioned on the roof or wall with the tapers oriented lengthwise, transverse, or at any other angle relative to the major axes of that surface.

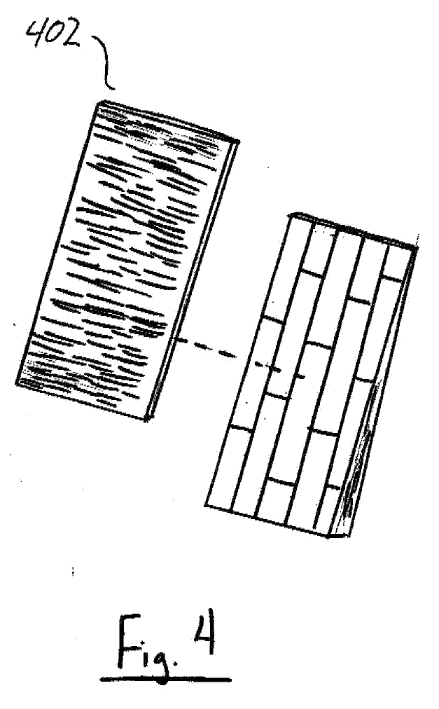

FIG. 3 depicts a perspective view of an embodiment showing an optional reinforcing backing 302. Here, the backing is depicted as a mesh material having a quadrilateral pattern. However, it can be mesh with any geometric pattern, interlocking, or layered material, or any other conventionally used configuration. The backing can be made of metal, polymer, plastic, textile, or any other known or conventionally used material. In this embodiment, it is depicted as a continuous sheet running along the entire backside of the piece. However, it can also cover any portion thereof. It can also be solid pieces cut into strips or various geometries and positioned in adjoining, interwoven, overlapping, or disconnected configurations when affixed to the bamboo layer. The thickness and rigidity of this material can vary according to weight, strength, aesthetic, and structural considerations. It can be affixed to the bamboo piece by any known and/or convenient adhesive such as, but not limited to, epoxies, water-based adhesives, films, and thermosefting adhesives.

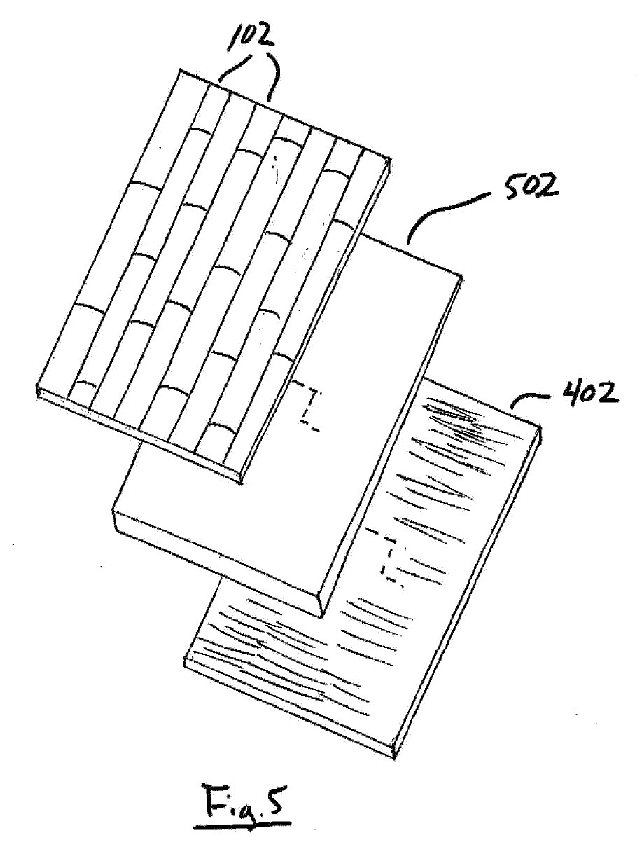

FIG. 4 depicts perspective view of another embodiment, wherein the optional reinforcing backing can be a bonded bamboo planar surface 402. This reinforcing planar surface 402 can be made from the interior portions of the sectioned bamboo and bonded together with any known and/or convenient bonding agent, such as, but not limited to, epoxies, water-based adhesives, films, and thermosetting adhesives. The reinforcing planar surface 402 can be oriented such that the longitudinal direction of the interior portions of bamboo used in the reinforcing planar surface 402 are transverse relative to the longitudinal direction of the sectioned bamboo segments 102 in the panel. It can be affixed to the bamboo piece by any known and/or convenient bonding agent such as, but not limited to, epoxies, water-based adhesives, films, and thermosetting adhesives,

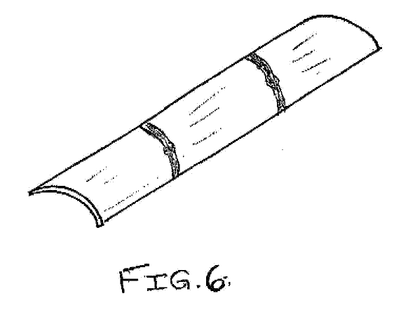

FIG. 5 depicts an alternative shingle embodiment of the present material, wherein an additional tapered layer 502 can be inserted between the layer of sectioned bamboo 102 and a reinforcing planar surface 402. The three layers can be bonded by any known and/or convenient bonding agent such as, but not limited to, epoxies, water-based adhesives, films, and thermosetting adhesives.

The surfaces of a panel or piece can be finished in any known or convenient fashion. The top or bottom surface of this embodiment may be left unfinished, finished to varying degrees of roughness, planed smooth, polished, textured, sculpted, or any other known and/or convenient finish. The top surface can have texture or sculpting for either aesthetic or functional purposes. Although texturing or sculpting of the bottom or backside surface may not serve any aesthetic purpose, it can facilitate affixing the pieces to an optional reinforcing backing 302, other structural components, or serve any other known and/or conventional purpose. The surface variances of this texturing should satisfy desired tolerances and can be sanded to meet such tolerances. However, in alternate embodiments the tolerances can allow for greater variation between adjacent bamboo stalk sections.

Various applied finishes can be added to the bamboo to add color to the material. Dyes, stains, and tints, which can be applied to the bamboo surface or be absorbed into the bamboo, can add color to the material while still allowing the natural look of the bamboo to show through. Paints can also be applied to cover the bamboo surface and obscure the natural look of the bamboo. Adding color to the material can allows for more flexibility in design by permitting a builder to either match the bamboo material to existing structures, or create a new contrasting look with an existing structure, or create a custom look for new construction.

The pieces can be tinted to enhance the aesthetic aspects in various ways. Shaving or sanding the bamboo to remove the outermost layer and then introducing the dye at either end of the bamboo piece can enhance the color of the material. The dye absorbs into the bamboo along its length, producing either a consistent or variegated coloration, depending on the exposure to the dye. Alternatively, a tint can be added to the adhesive or surface glaze, Which would lend a transparent hint of color of varying degrees to the piece without obscuring the appearance of the bamboo. Any other known and/or convenient method for tinting or coloring the bamboo can also be used.

These applied finishes can also have various levels of gloss or contain additional substances to add texture to the surface. Gloss levels can include, but are not limited to, high gloss, low gloss, satin, eggshell, matte, or any other known and/or conventionally used levels. Finishes can also have other substances, such as, but not limited to, particles of various densities, sizes, and grits. Different building applications can require a particular glossiness or texture. For example, a builder can require shingles or panels with a high gloss to achieve a desired appearance or to enhance water repellency. Likewise, a finish that contains gritty particles can produce a piece with interesting texture or non-slip properties.

Other finishes and treatments can also be added to provide protection against ultraviolet (UV) rays or other environmental conditions, make the material fire retardant, or seal the material to provide resistance to potential water damage. These can be applied in liquid, gel, film, or any other known and/or convenient form, and can be applied separately or as a combination substance. Finishes and treatments can be applied in any known and/or convenient number of layers. In one embodiment of the present material, a UV-protective coating can be applied in three layers.

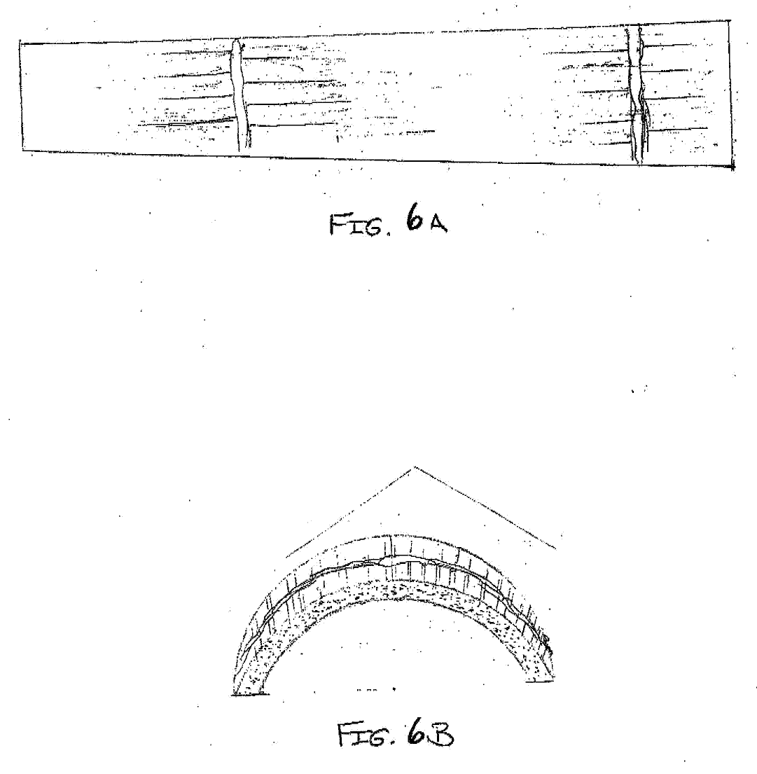

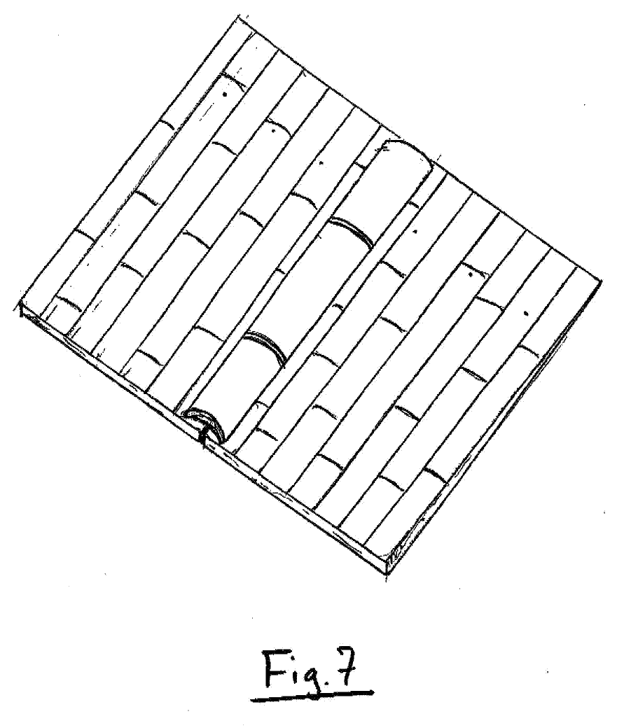

FIG. 6 depicts a perspective view of a ridge cap embodiment of this material that can be used in roofing applications. This ridge cap can be a longitudinal section of bamboo of arc length less than 180 degrees. It can be cut to any length or taper configuration known and/or convenient for the application. It can also cover seams between pieces in other parts of a structure.

FIG. 6(a) depicts a side view of a ridge cap embodiment. Here, the embodiment is shown with a longitudinal taper, giving it a slight elevation when in position on a roof ridge, but the piece can also be of uniform height along its length. FIG. 6(b) shows an end view of a ridge cap embodiment, where it is taken from a substantially 180-degree section of bamboo.

FIG. 7 depicts a ridge cap embodiment in use with two rectangular shingle embodiments of the present material. A ridge cap embodiment can be used to cover the junction of two adjoining pieces.

All of the above-described embodiments may also be fabricated from synthetic materials to have the look and properties of bamboo.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1 A material comprising:
a plurality of longitudinally sectioned bamboo segments each having a first and a second longitudinal edge; and
a bonding agent;
wherein said first longitudinal edge of one of said longitudinally sectioned bamboo segments is coupled adjacent to one of a first longitudinal edge and a second longitudinal edge of a second longitudinally sectioned bamboo segments with said bonding agent.

2. The material of claim 1, wherein said first longitudinal edge of one of said longitudinally sectioned bamboo segments is overlapping one of a first longitudinal edge and a second longitudinal edge of a second longitudinally sectioned bamboo segments with said bonding agent.

3. The material of claim 1, wherein the longitudinally sectioned bamboo segments are interwoven and bonded with said bonding agent.

4. The material of claim 1, wherein the bonding agent is selected from the group consisting of: epoxies, water-based adhesives, films, and thermosetting adhesives.

5. The material of claim 1, further comprising a reinforcing backing material.

6. The material of claim 5, wherein said reinforcing backing material is a planar surface comprised of the interior portions of sectioned bamboo bonded together with a bonding agent selected from the group consisting of: epoxies, water-based adhesives, films, and thermosetting adhesives.

7. The material of claim 5, wherein the bamboo is partially saturated by a treatment selected from the group consisting of: coloring agent, waterproofing agent, UV protecting agent, and fire retardant.

8. The material of claim 5, further comprising a surface treatment selected from the group consisting of: coloring agent, texturing agent, waterproofing agent, UV protecting agent, and fire retardant.

9. The material of claim 5, wherein the bamboo is partially saturated by a treatment selected from the group consisting of: coloring agent, waterproofing agent, UV protecting agent, and fire retardant; and further comprising a surface treatment selected from the group consisting of a coloring agent, waterproofing agent, UV protecting agent, and fire retardant.

10. A material comprising:
a plurality of longitudinally sectioned synthetic bamboo segments each having a first and a second longitudinal edge; and
a bonding agent;
wherein said first longitudinal edge of one of said longitudinally sectioned synthetic bamboo segments is coupled adjacent to one of a first longitudinal edge and a second longitudinal edge of a second longitudinally sectioned synthetic bamboo segments with said bonding agent.

11. The material of claim 9, wherein said first longitudinal edge of one of said longitudinally sectioned bamboo segments is overlapping one of a first longitudinal edge and a second longitudinal edge of a second longitudinally sectioned bamboo segments with said bonding agent.

12. The material of claim 9, wherein the longitudinally sectioned bamboo segments are interwoven and bonded with said bonding agent.

13. The material of claim 9, wherein the bonding agent is selected from the group consisting of: epoxies, water-based adhesives, films, and thermosetting adhesives,

14. The material of claim 9, further comprising a reinforcing backing material.

15. The material of claim 13, wherein the synthetic bamboo is partially saturated by a treatment selected from the group consisting of: coloring agent, waterproofing agent, UV protecting agent, and fire retardant.

16. The material of claim 13, further comprising a surface treatment selected from the group consisting of: coloring agent, texturing agent, waterproofing agent, UV protecting agent, and fire retardant.

17. The material of claim 13, wherein the bamboo is partially saturated by a treatment selected from the group consisting of: coloring agent, waterproofing agent, UV protecting agent, and fire retardant; and further comprising a surface treatment selected from the group consisting of: a coloring agent, waterproofing agent, UV protecting agent, and fire retardant.
